(19) United States
(12) Patent Application Publication
(10) Pub. No.: US 2018/0357750 A1
(43) Pub. Date: Dec. 13, 2018

(54) DEMOSAICKING FOR MULTI-CELL IMAGE SENSOR

(71) Applicant: MEDIATEK INC., Hsin-Chu (TW)

(72) Inventors: Yi-Chen CHEN, New Taipei City (TW); Jing-Ying CHANG, Taipei City (TW); Yi-Hsien LIN, Huwei Township, Yunlin County (TW)

(21) Appl. No.: 16/001,059

(22) Filed: Jun. 6, 2018

Related U.S. Application Data
(60) Provisional application No. 62/516,144, filed on Jun. 7, 2017.

(51) Int. Cl. G06T 3/40

(52) U.S. Cl. CPC G06T 3/4015; G06T 2200/32; G06T 3/4038

(57) ABSTRACT

A demosaicking method for an image having a multi-cell mosaic pattern, wherein the multi-cell mosaic pattern includes a first quarter, a second quarter, a third quarter, and a fourth quarter. Each quarter includes multiple cells, and each cell includes a pixel value. The method includes: obtaining the image; performing an image-dividing process on the image to obtain four Bayer plane images; performing a quarter-resolution demosaicking process on each of the four quarter-resolution plane images to obtain a quarter-resolution image in each color channel; and performing an image-combining process on the quarter-resolution image in each color channel to generate a first full-resolution image in each color channel.

### CROSS REFERENCE TO RELATED APPLICATIONS

This application claims the benefit of U.S. Provisional Application No. 62/516,144 filed on Jun. 7, 2017, the entirety of which is incorporated by reference herein.

### BACKGROUND OF THE INVENTION

### Field of the Invention

The invention relates to an image processing method, and, in particular, to a demosaicking method thereof.

### Description of the Related Art

Digital cameras often acquire imagery using a single-chip CCD (Charge Coupled Device) or CMOS (Complementary Metal Oxide Semiconductor) sensor whose surface is covered with a color filter array (CFA). The CFA consists of a set of spectrally selective filters that are arranged in an interleaving pattern so that each corresponding sensor pixel samples one of the three primary color values (for example, red, green and blue values). These sparsely sampled color values are referred to as CFA samples. To render a full-color image from the CFA, an image reconstruction process commonly referred to as CFA demosaicking is performed. The Bayer pattern, as illustrated in FIG. 1, is one of the many possible realizations of color filter arrays (CFA).

Technological advancements have allowed the resolution of color image sensors to become higher and higher. As a result, the dimensions of a color filter array need no longer be limited to the Bayer pattern, and it can be extended to multi-cell CFA for image sensors such as 4-cell CFA where each 2×2 array (as 4 collocated cells) comes with the same color, 9-cell CFA where each 3×3 array (as 9 collocated cells) comes with the same color, and 16-cell CFA where each 4×4 array (as 16 collocated cells) comes with the same color.

Accordingly, there is demand for a demosaicking method and circuit for a color image sensor in the multi-cell-structure CFA to recover the original high-resolution image.

### BRIEF SUMMARY OF THE INVENTION

A detailed description is given in the following embodiments with reference to the accompanying drawings.

In an exemplary embodiment, a demosaicking method for an image having a multi-cell mosaic pattern, wherein the multi-cell mosaic pattern includes a first quarter, a second quarter, a third quarter, and a fourth quarter. Each quarter includes multiple cells, and each cell includes a pixel value, the method includes: obtaining the image; performing an image-dividing process on the image to obtain four Bayer plane images; performing a quarter-resolution demosaicking process on each of the four quarter-resolution plane images to obtain a quarter-resolution image in each color channel; and performing an image-combining process on the quarter-resolution image in each color channel to generate a first full-resolution image in each color channel.

In another exemplary embodiment, a demosaicking circuit for processing an image having a multi-cell mosaic pattern, wherein the multi-cell mosaic pattern includes a first quarter, a second quarter, a third quarter, and a fourth quarter. Each quarter includes multiple cells, and each cell includes a pixel value. The demosaicking circuit includes an initial demosaicking circuit. The initial demosaicking circuit is configured to obtain the image; perform an image-dividing process on the image to obtain four Bayer plane images; perform a quarter-resolution demosaicking process on each of the four Bayer plane images to obtain a quarter-resolution image in each color channel; and perform an image-combining process on the quarter-resolution image in each color channel to generate a first full-resolution image in each color channel.

In yet another exemplary embodiment, a demosaicking circuit for processing an image having a multi-cell mosaic pattern, wherein the multi-cell mosaic pattern includes a first quarter, a second quarter, a third quarter, and a fourth quarter. Each quarter includes multiple cells, and each cell includes a pixel value. The demosaicking circuit includes an initial demosaicking circuit and an image-cascading circuit. The initial demosaicking circuit is configured to: obtain the image; perform an image-dividing process on the image to obtain four Bayer plane images; perform a quarter-resolution demosaicking process on each of the four Bayer plane images to obtain a quarter-resolution image in each color channel; and perform an image-combining process on the quarter-resolution image in each color channel to generate a first full-resolution image in each color channel. The image-cascading circuit is configured to perform an image-cascading process on the first full-resolution image in each color channel to obtain a second full-resolution image in each color channel. The image-cascading process includes one or more second color-resampling methods and second demosaicking methods, and each second color-resampling method corresponds to one of the second demosaicking methods. The one or more iterations are performed in the image-cascading process, and each iteration includes one of the second color-resampling methods and a corresponding second demosaicking method.

### BRIEF DESCRIPTION OF THE DRAWINGS

The invention can be more fully understood by reading the subsequent detailed description and examples with references made to the accompanying drawings, wherein:

FIG. 1 is an example of the Bayer pattern;

FIG. 2A is a diagram of a 4-cell color filter array in accordance with an embodiment of the invention;

FIG. 2B is a diagram of a 9-cell color filter array in accordance with an embodiment of the invention;

FIG. 2C is a diagram of a 16-cell color filter array in accordance with an embodiment of the invention;

FIG. 3 is a block diagram of an imaging device in accordance with an embodiment of the invention;

FIG. 4A is a flow chart of a demosaicking method for the color image sensor in accordance with an embodiment of the invention;

FIG. 4B is a flow chart of a demosaicking method for the color image sensor in accordance with an embodiment of the invention;

FIG. 5 is a flow chart of the initial demosaicking stage in accordance with an embodiment of the invention;

FIGS. 6A-1 and 6A-2 are portions of a first arrangement of the Bayer planes in accordance with another embodiment of the invention;

FIGS. 6B-1 and 6B-2 are portions of second arrangement of the Bayer planes in accordance with another embodiment of the invention;

FIGS. 7A-7D are diagrams of different neighborhood areas in the image using the GBRG Bayer pattern in accordance with an embodiment of the invention;

FIG. 8A is an example of the GBRG Bayer pattern;

FIG. 8B is an example of the Yamanaka pattern;

FIGS. 8C-1˜8C-16 are diagrams of different 3×3 neighborhood areas in different types in the image using the Yamanaka pattern in accordance with an embodiment of the invention;

FIG. 9A is an example of the Lukac pattern; and

FIGS. 9B-1˜9B-16 are diagrams of different 3×3 neighborhood areas in different types in the image using the Lukac pattern in accordance with an embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

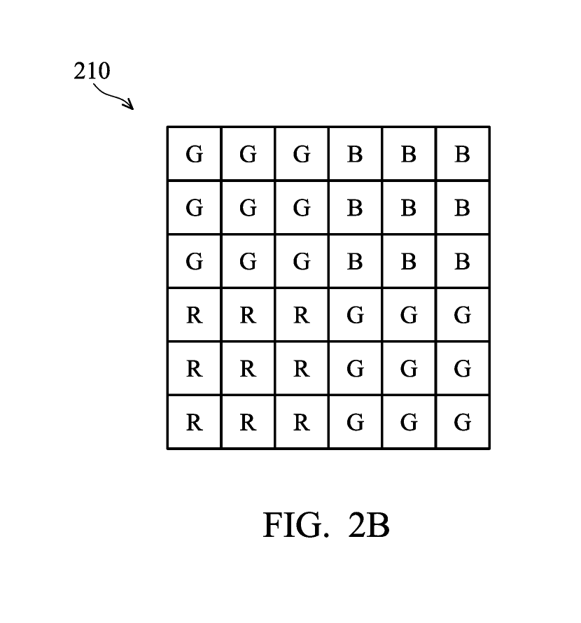

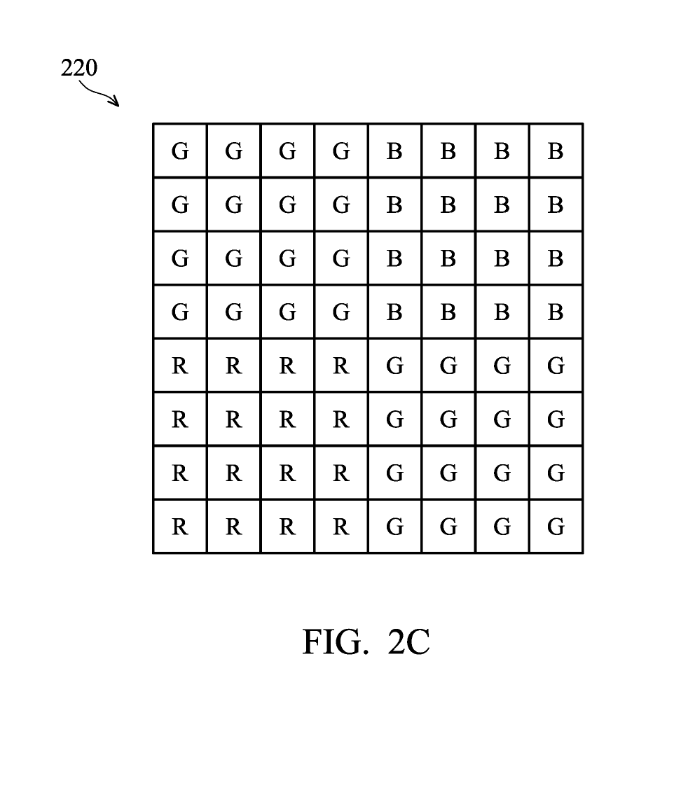

The present application discloses a method and/or circuit for demosaicking for multi-cell image sensor. The multi-cell image sensor may be a 4-cell CFA (or a 9-cell CFA, or a 16-cell CFA, . . . etc.) for image capture. For the sake of brevity, the disclosure uses image sensor with a 4-cell CFA as an example to illustrate the idea of the invention. FIG. 2A is a diagram of a 4-cell color filter array in accordance with an embodiment of the invention. The 4-cell color filter array can be repeatedly arranged in a color image sensor, thereby capturing a mosaicked image. As illustrated in FIG. 2A, the 4-cell color filter array 200 includes 16 pixels such as four red pixels, four blue pixels, and eight green pixels. Specifically, the upper-left quarter (i.e. 2×2 array), the upper-right quarter, the bottom-left quarter, and the bottom-right quarter in the 4-cell color filter array 200 include four green pixels (denoted as G in FIG. 2), four blue pixels (denoted as B in FIG. 2), four red pixels (denoted as R in FIG. 2), and four green pixels, respectively. The upper-left quarter, the upper-right quarter, the bottom-left quarter, and the bottom-right quarter can be collectively regarded as a Bayer pattern. Alternatively, the 4-cell CFA 200 can also be regarded as a quad Bayer pattern structure. FIG. 2B is a diagram of a 9-cell color filter array in accordance with an embodiment of the invention. The 9-cell color filter array can be repeatedly arranged in a color image sensor, thereby capturing a mosaicked image. As illustrated in FIG. 2B, the 9-cell color filter array 210 includes 36 pixels such as nine red pixels, nine blue pixels, and eighteen green pixels. FIG. 2C is a diagram of a 16-cell color filter array in accordance with an embodiment of the invention. The 16-cell color filter array can be repeatedly arranged in a color image sensor, thereby capturing a mosaicked image. As illustrated in FIG. 2C, the 16-cell color filter array 220 includes 64 pixels such as 16 red pixels, 16 blue pixels, and 32 green pixels.

Conventional techniques for demosaicking the mosaicked image using the 4-cell CFA 200 is down-sampling the four pixels of each quarter in the CFA 200 into one pixel. For example, four pixels in each of the upper-left quarter, the upper-right quarter, the bottom-left quarter, and the bottom-right quarter are down-sampled to one pixel respectively, says averaging the pixel values of the 4 pixels of an quarter to generate the down-sampled pixel. The down-sampled pixels from each quarter form a Bayer pattern. As a result, conventional demosaicking techniques for the Bayer pattern can be used to obtain a low-resolution image in each color channel, and then up-sample the low-resolution image to a full-resolution image. However, such conventional techniques may result in a resolution loss, and is not suitable for adjacent co-channel pixels in different exposures (e.g. long exposure and short exposure) of HDR applications.

In the present application, a demosaicking method is provided to recover the full-resolution image in each color channel (e.g. R, G, B) from the mosaicked image using a multi-cell CFA, such as the CFA 200 and other types of 4-cell CFAs.

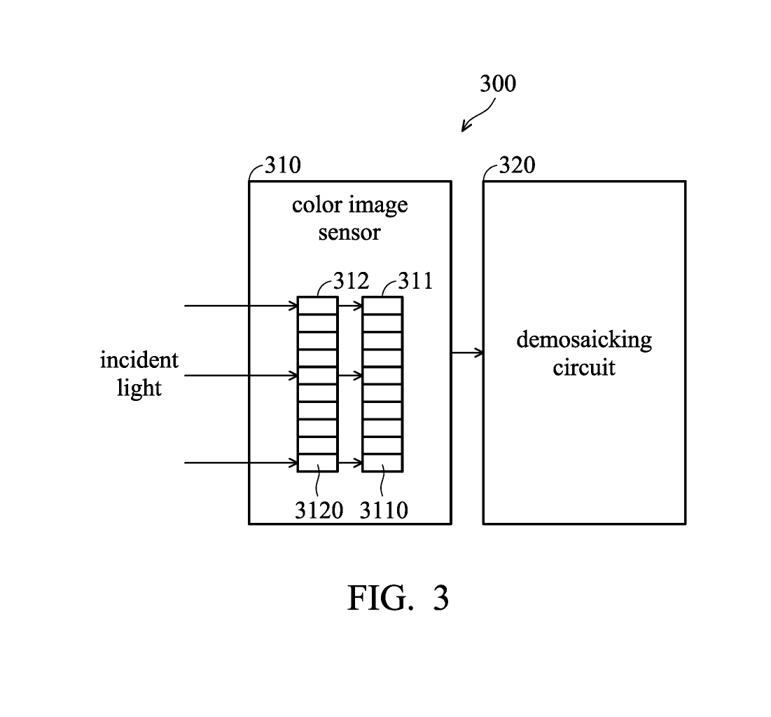

FIG. 3 is a block diagram of an imaging device in accordance with an embodiment of the invention. The imaging device 300 includes a color image sensor 310 and a demosaicking circuit 320. The color image sensor 310 may include a sensor array 311 and a filter array 312. The sensor array 311 includes a plurality of photoelectric elements 3110 that are arranged in a two-dimensional manner. The photoelectric elements 3110 may be implemented by charged coupled device (CCD) sensors or complementary metal oxide semiconductor (CMOS) sensors.

In some implementations, the color image sensor 310 further includes analog-to-digital converters (ADCs). For example, the color image sensor 310 may output analog signals of an image in an RGB format, and the ADCs may convert the analog signals into digital signals.

The filter array 312 includes a plurality of color filters 3120 that are arranged in a two-dimensional manner. The photoelectric elements 3110 and the color filters 3120 have a one-to-one correspondence. The color filters 3120 may include green filters, red filter, and blue filters that filter the green light, red light, and blue light from incident light, respectively. In an embodiment, the color filters 3120 are arranged into a plurality of 4×4 arrays such as the CFA 200 shown in FIG. 2. Accordingly, a mosaicked image can be obtained from the color image sensor 310.

The demosaicking circuit 320 may be a portion of the image processing pipeline, and the demosaicking circuit 320 is configured to demosaic the mosaicked image from the color image sensor 310 to recover the full-resolution image in each color channel. In some implementations, the demosaicking circuit 320 may be implemented by an integrated circuit (IC), or an equivalent digital logic circuit. In some other implementations, the demosaicking circuit 320 may be a digital signal processor (DSP), an image signal processor (ISP), or a general-purpose processor, but the invention is not limited thereto.

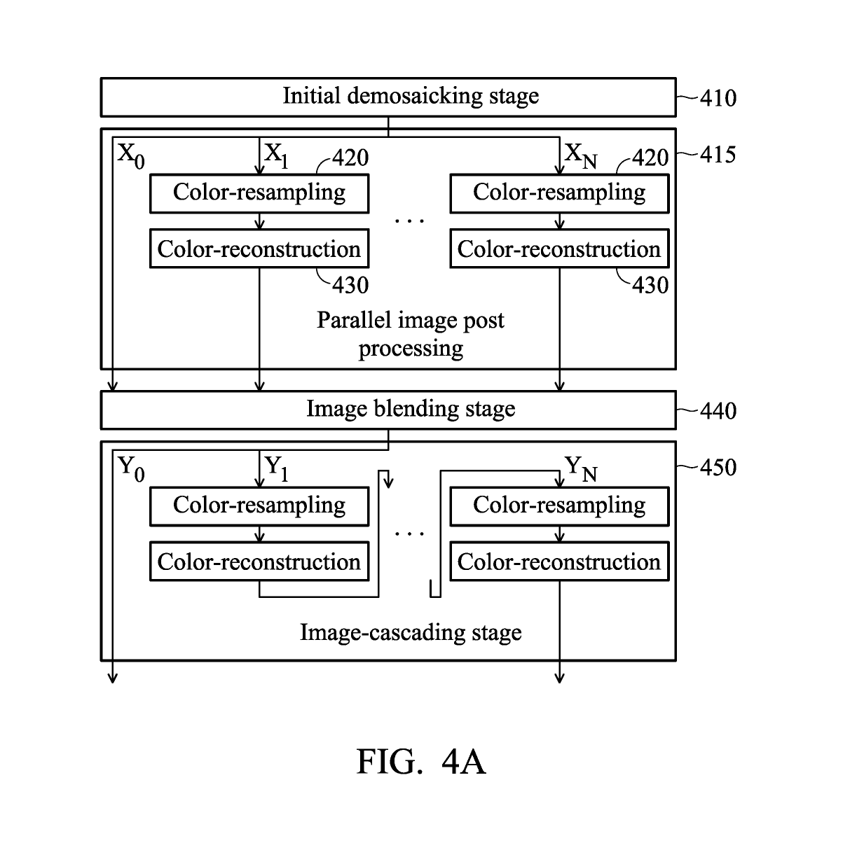

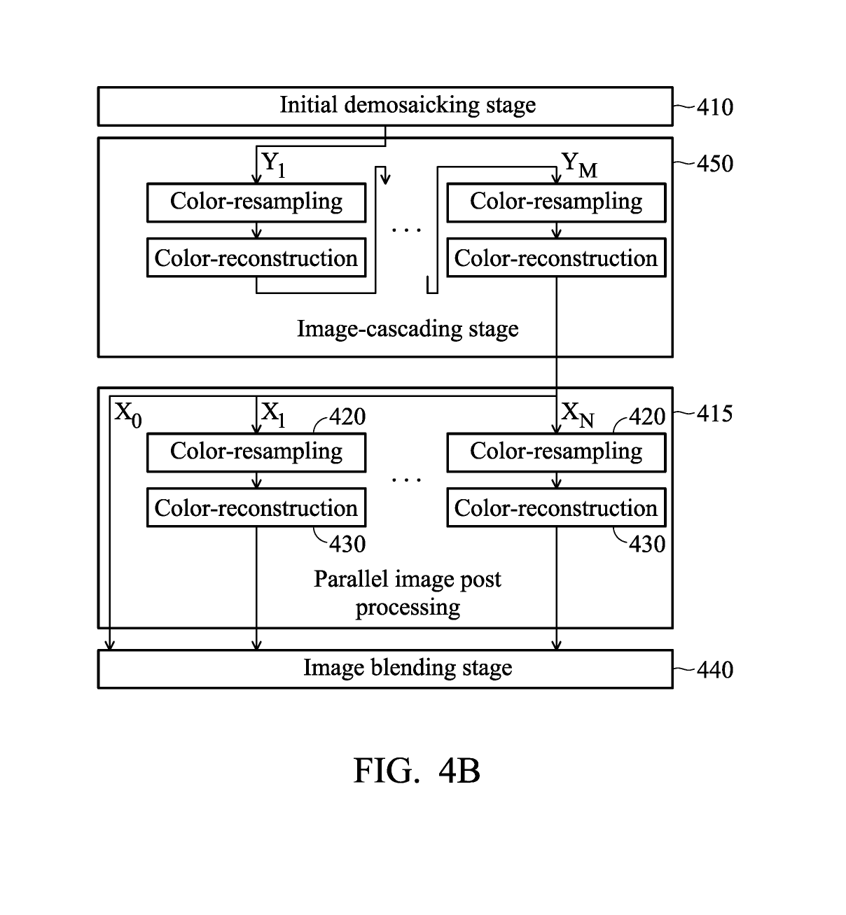

FIG. 4A is a flow chart of a demosaicking method for the color image sensor in accordance with an embodiment of the invention. The demosaicking method in FIG. 4A may be designed for the color image sensor 310 that includes 4-cell CFAs 200. For example, there are four stages of the demosaicking method, such as an initial demosaicking stage 410, a parallel image post-processing stage 415, an image-blending stage 440, and an image-cascading stage 450. The parallel image post processing stage 415 further includes a color-resampling stage 420, a color-reconstruction stage 430. It should be noted that each of the stages 410, 415, 420, 430, 440 and 450 can be implemented by a corresponding digital circuit in the demosaicking circuit 320.

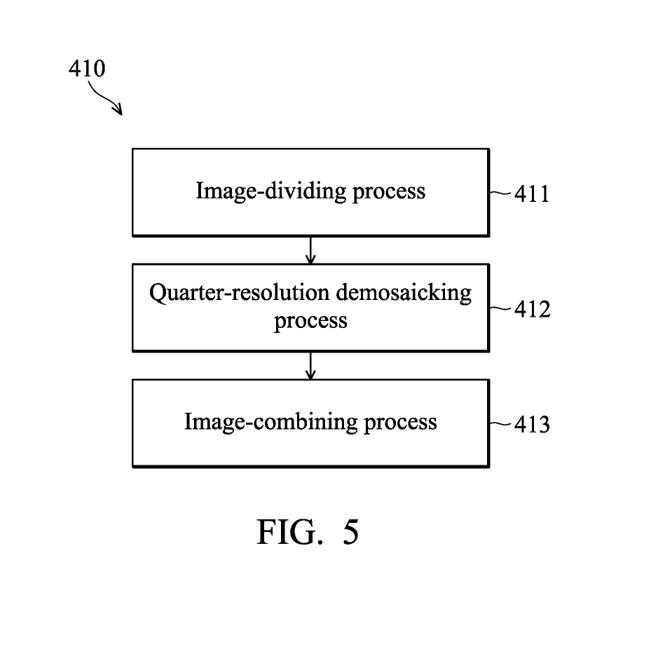

In the initial demosaicking stage 410, an initial demosaicking process is performed on an input image received from the color image sensor 310 to generate a full-resolution images for each color channel. For example, the initial demosaicking stage includes an image-dividing process, a quarter-resolution demosaicking process, and an image-combining process, and the details of the initial demosaicking stage are described in the embodiment of FIG. 5.

The parallel image post processing stage 415 includes a plurality of image post processes. Each of the image post process performs a post processing to the full-resolution images in a parallel manner. With respective to the number of the image post processes, given that Xᵢ (i=0, 1, . . . , N, and i is an integer) represents the i-th image post process. Further, each of the image post process includes a color-resampling stage 420 for performing a color-resampling process, and a color-reconstruction stage 430 for performing a color-reconstruction process, respectively.

In the color-resampling stage 420, a color-resampling process is performed on the full-resolution images for each color channel to generate one or more color-resampled images. The color-resampling processes is performed on the full-resolution images from the initial demosaicking stage for each color channel to generate a mosaicked color-resampled image. In other word, the color-resampling processes, for each image pixel of the mosaicked color-resampling image, samples the color values from the RGB color channels of the full-resolution images to generate the mosaicked color-resampled image having a mosaic pattern. For example, the mosaicked color-resampled image has a Bayer pattern or other mosaic pattern, e.g. Yamanaka pattern defined in U.S. Pat. No. 4,054,906; Lukac pattern defined in “Color Filter Arrays: Design and Performance Analysis,” IEEE Transactions on Consumer Electronics, vol. 51, no. 4, pp. 1260-1267, November 2005.; Vertical stripe pattern, diagonal stripe pattern, modified Bayer pattern, and pseudo-random pattern which are all defined in FillFactory, “Technology image sensor: the color filter array,”; HVS-based pattern defined in “A perceptually based design methodology for color filter arrays,” IEEE Int. Con. Acoustics, Speech, and Signal Processing (ICASSP'04), vol. 3, pp. 473-476, May 2004.; and Fujifilm X-trans pattern defined in Fujifilm, “Fujifilm X-Trans sensor technology,”. Yet in another embodiment, the mosaicked color-resampling image may has a mosaic pattern which is a rotation of the above mentioned mosaic RGB patterns (e.g. 0 degree, 180 degrees, 90 or −90 degrees).

In the color-reconstruction stage 430, a color-reconstruction process is performed on each of the color-resampled images respectively to generate a full-resolution demosaicked image for each color channel. In other word, in the color reconstruction process generally a CFA demosaicking is performed to obtain the full-resolution demosaicked image for each color channel. The number of color-resampling processes equals that of the color-reconstruction processes, and each color-reconstruction process corresponds to one of the color-resampling process.

Specifically, each color-resampling process is followed by a corresponding color-reconstruction process. Given Xᵢ and Xⱼ respectively represent the i-th and j-th color-resampling methods (i.e. i and j are positive integers from 1 to N), Xᵢ and Xⱼ may be in the same pattern type with different resampling method, such as an RGGB Bayer pattern and a GRBG Bayer pattern. Alternatively, Xᵢ and Xⱼ in the color-resampling stage 420 may be the same color-resampling method followed by different color-reconstruction algorithms in the color-reconstruction stage 430.

It should be noted that the various color-resampling processes in stage 420 followed by the corresponding color-reconstruction processes in stage 430 can be performed in parallel.

In the image-blending stage 440, an image-blending process is performed on the full-resolution demosaicked images in each color channel to obtain a fused image. For example, the fused image is computed using the N demosaicked image in each color channel. The fusion may include any linear and non-linear pooling functions along the temporal i's (i=1, 2, . . . , N) in the spatial domain or the spectral domain. The pooling can be done with the original resolution, or with multi-resolution in its pyramid representation. Common pooling functions may be mean, weighted average, product, maximum, minimum, and medium (by re-ordering).

For example, in a weighted average blending scenario, denote the N RGB images generated from the stages 415 by J₁, J₂, . . . , J_{N}, and denote the corresponding normalized weights by w₁, w₂, . . . w_{N}, the fused image J can be computed using the following equation:

JΣₖ₌₁^{N}wₖJₖ (1)

In the image-cascading stage 450, cascaded iterations of color-resampling and reconstruction processes are performed. Let Yⱼ (j=1, 2, . . . , M) represent the j-th iteration which includes a color-resampling process and a reconstruction process. These iterations of Yⱼ color-resampling and reconstruction processes are done in a sequential order. For example, the first color-resampling process is followed by the first full-resolution demosaicking process. The first color-resampling process and the first full-resolution demosaicking process are regarded as the first iteration. The second color-resampling process is performed on the output full-resolution image of the first full-resolution demosaicking process, and is followed by the second full-resolution demosaicking process. After the M-th iteration is completed, full-resolution images for each color channel can be obtained.

In an embodiment, the color-resampling and reconstruction processes Yⱼ in the image-cascading stage 450 may apply the same or the similar processes with those in the stages 420 and 430. In another embodiment, the color-resampling and reconstruction processes Yⱼ in the image-cascading stage 450 can be different from those in the stages 420 and 430. Additionally, the number N in the stages 415 may be different from the number M in the stage 450.

It should be noted that it is assumed that the numbers N and M are not zero in the aforementioned embodiment. In some embodiments, the stages 415˜450 can be omitted in the flow of FIG. 4A. For example, both the numbers N and M may be 0, and the output full-resolution image in each color channel can be obtained after the stage 410. Alternatively, the number M is 0 and the number N is not zero. In this situation, the stages 440 and 450 are bypassed, and the output full-resolution image in each color channel can be obtained after the stage 430.

FIG. 4B is a flow chart of a demosaicking method for the color image sensor in accordance with an embodiment of the invention. The flow in FIG. 4B is similar to that in FIG. 4A. The difference between the flows in FIG. 4A and FIG. 4B is that the stage 450 is performed prior to the stages 420 and 430 in FIG. 4B.

FIG. 5 is a flow chart of the initial demosaicking stage in accordance with an embodiment of the invention. In the initial demosaicking stage 410, an initial demosaicking process is performed on an input image from the color image sensor to generate a full-resolution images for each color channel. For example, the initial demosaicking stage includes an image-dividing process 411, a quarter-resolution demosaicking process 412, and an image-combining process 413.

In the image-dividing process 411, an image-dividing operation is performed on an input image (i.e. a mosaicked image) from the color image sensor 310 to obtain a plurality of Bayer planes. For purposes of description, the image-dividing process 411 is based on an input image having a 4-cell mosaic pattern.

In the quarter-resolution demosaicking process 412, a quarter-resolution demosaicking operation is performed on each Bayer plane to obtain quarter-resolution images for each color channel.

In the image-combining process 413, an image-combining process is performed to combine the quarter-resolution images to generate full-resolution images for each color channel.

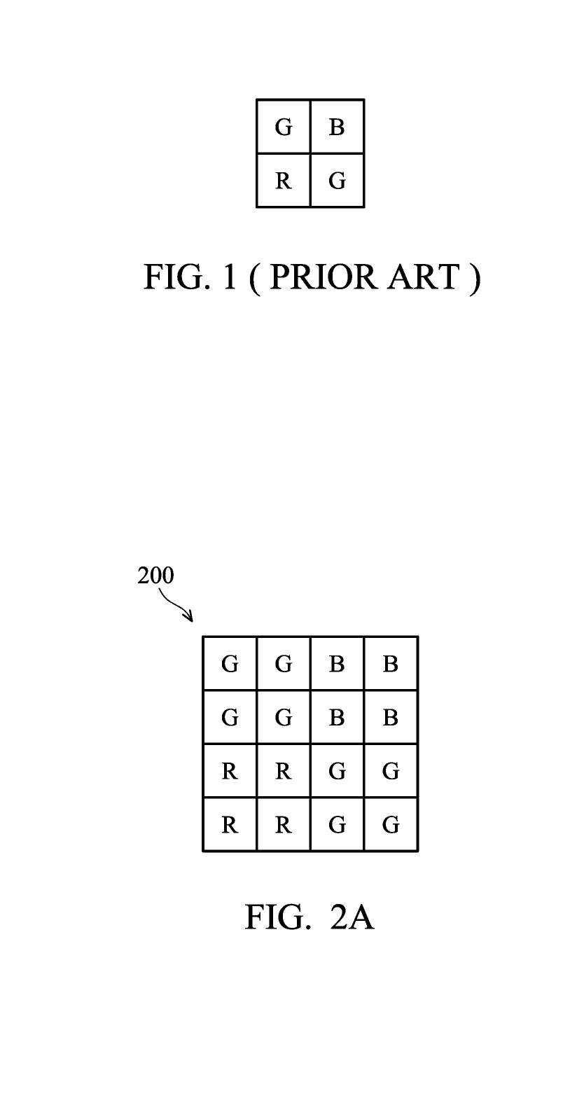

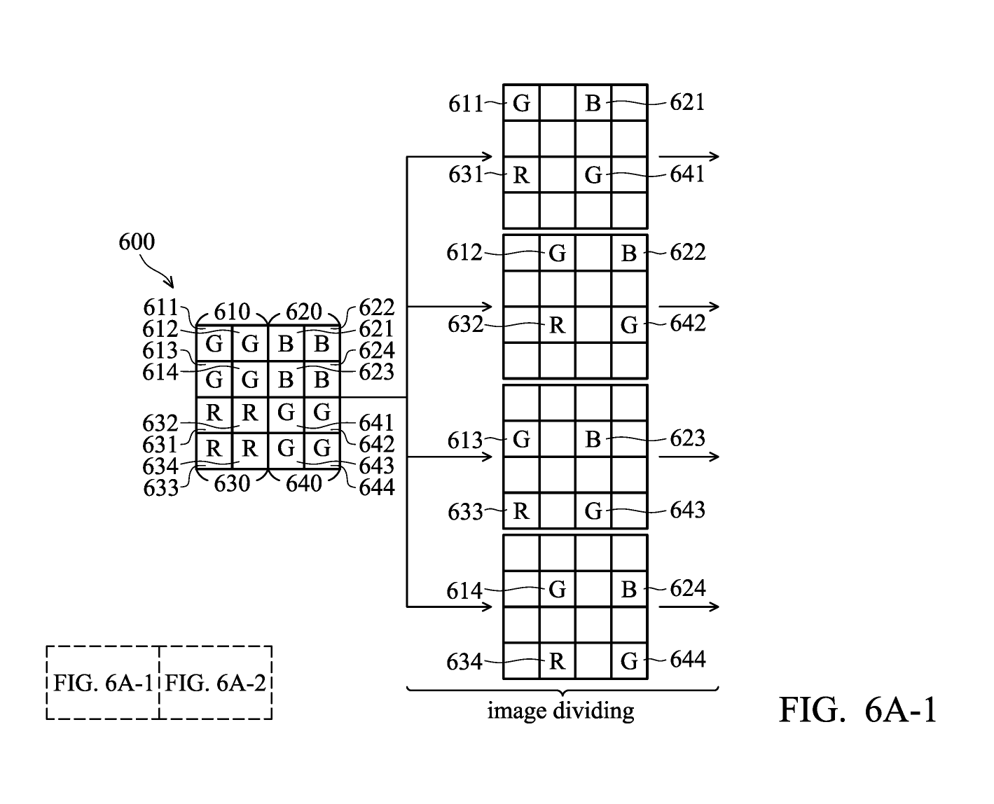

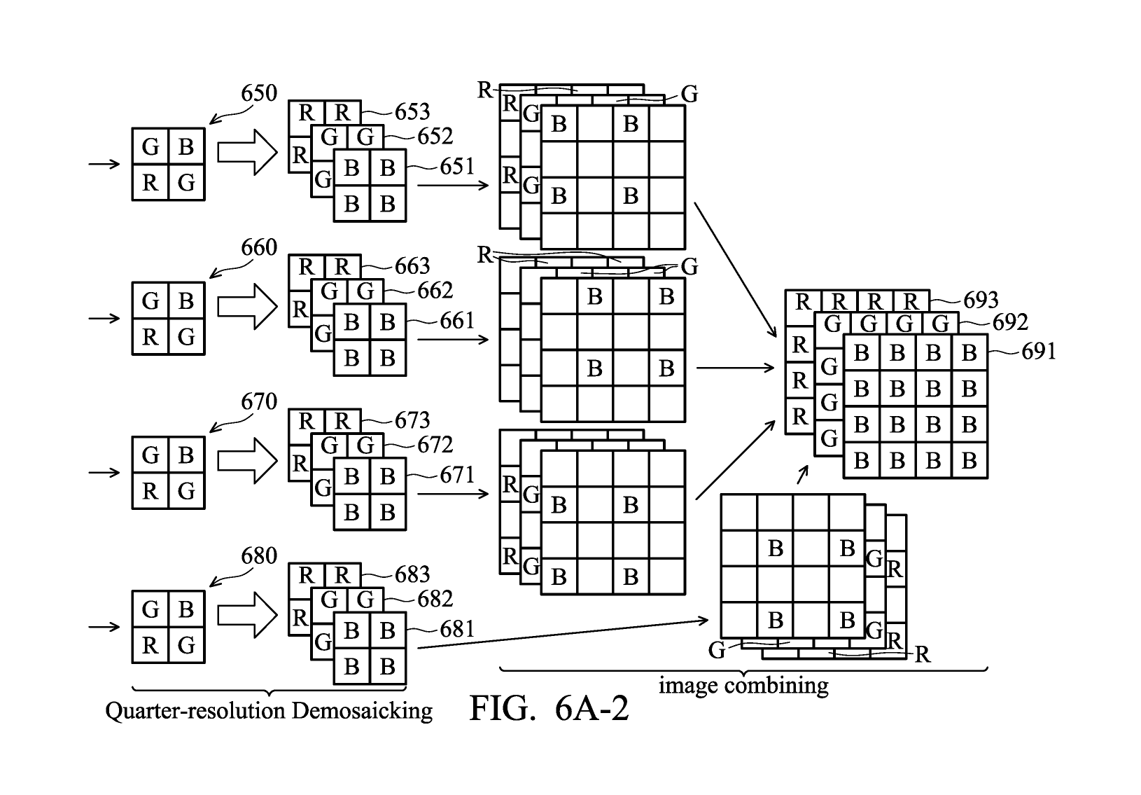

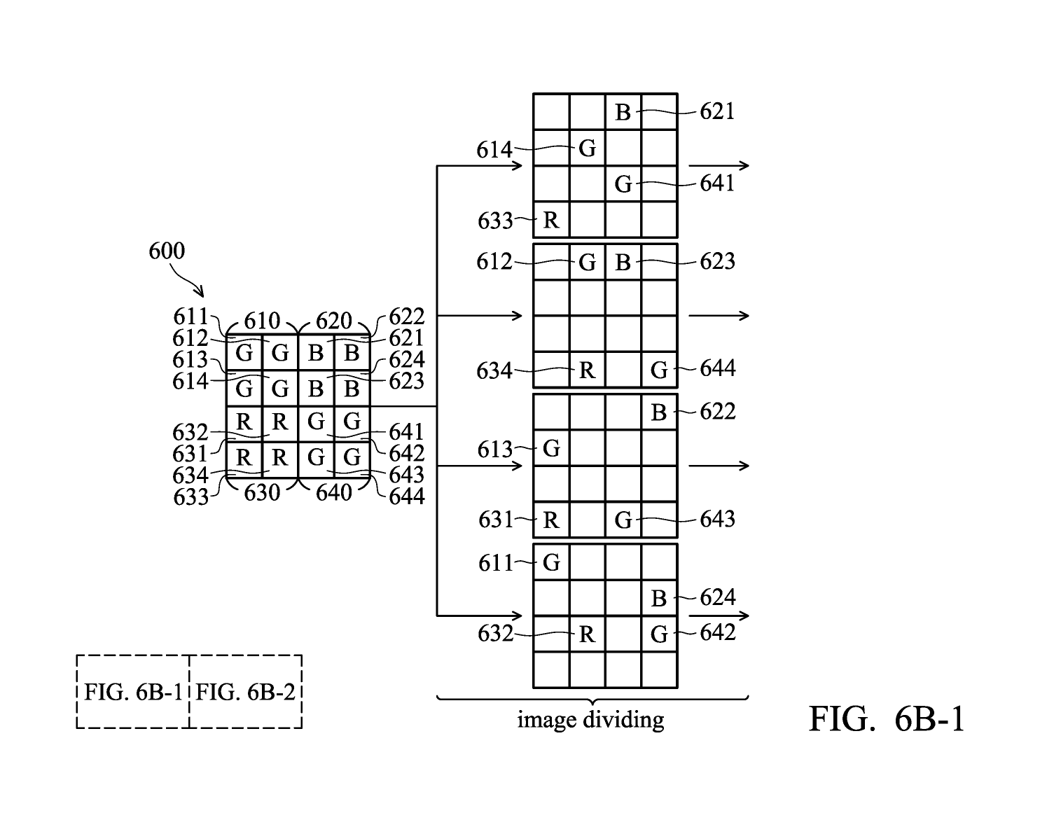

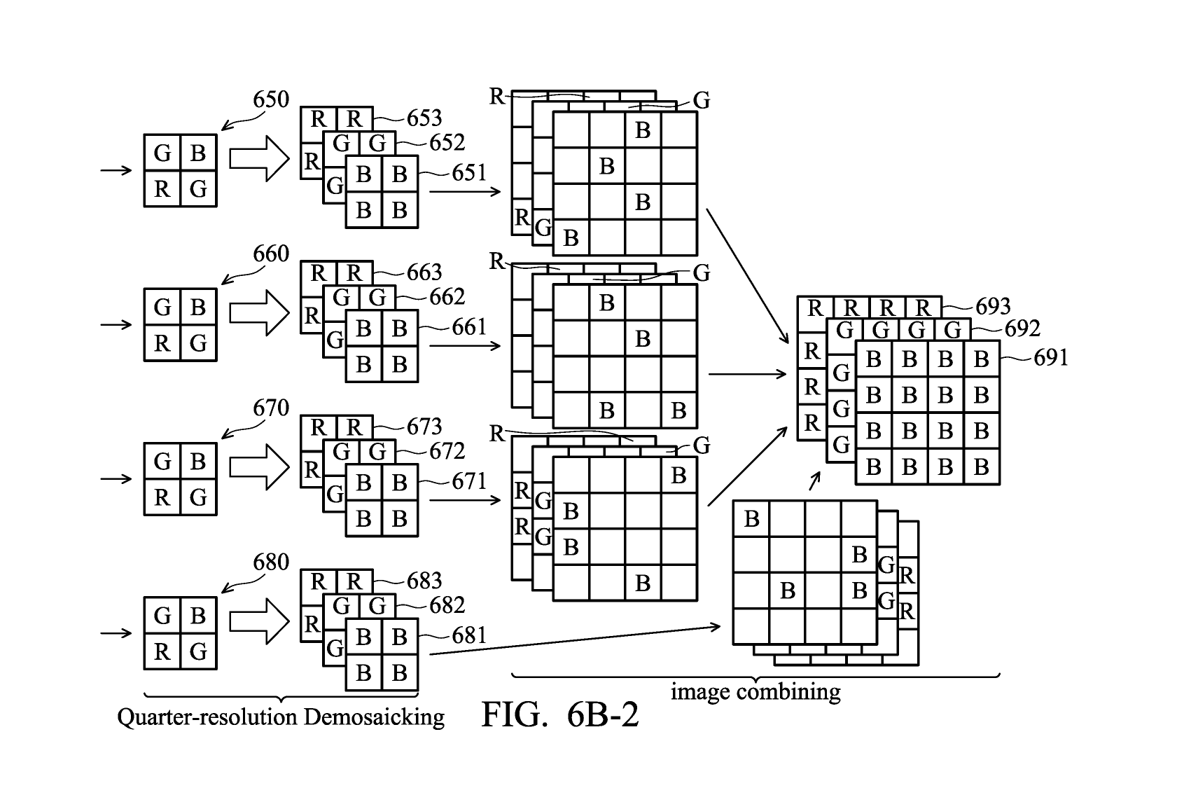

FIG. 6A shows a first arrangement of the 4-cell mosaic pattern 600 in accordance with another embodiment of the invention. Referring to FIG. 6A, the input image is a mosaicked image having a plurality of 4-cell mosaic pattern 600. For the sake of brevity, FIG. 6A shows only a portion of the input image which contains one 4-cell mosaic pattern 600 of the input image, the skilled in the art should appreciated that the 4-cell mosaic pattern 600 is repeatedly appeared in the whole input image. The 4-cell mosaic pattern 600 includes a upper-left quarter 610, a upper-right quarter 620, a bottom-left quarter 630, and a bottom-right quarter 640, and each of the quarters 610, 620, 630, and 640 include four pixels that each contains the green color value (denoted as G in FIG. 6A-1), blue color value (denoted as B in FIG. 6A-1), red color value (denoted as R in FIG. 6A-1), and green color value of the input image 600, respectively. The image-dividing operation is to separate the color values of the four pixels in the quarters 610, 620, 630, and 640 into four Bayer planes.

As illustrated in FIG. 6A, the upper-left pixels 611, 621, 631, and 641 in the quarters 610˜640 are assigned to Bayer plane 650, and the positions of the pixels 611, 621, 631, and 641 in the Bayer plane 650 follow the relative position of the quarters 610, 620, 630, and 640 in the 4-cell mosaic pattern. Similarly, the remaining pixels (e.g. 612-614, 622-624, 632-634 and 642-644) in the quarters 610, 620, 630, and 640 are respectively assigned to the Bayer planes 660, 670, and 680, as illustrated in FIG. 6A.

The quarter-resolution demosaicking process 412 is to demosaic each of the Bayer planes 650, 660, 670, and 680 into quarter-resolution images in color channels. For example, after demosaicking the Bayer plane 650, quarter-resolution images 651 for the blue color, quarter-resolution images 652 for the green color and quarter-resolution images 653 for the red color are generated, respectively. Similarly, corresponding quarter-resolution images 661˜663, 671˜673, and 681-683 can be obtained after demosaicking the Bayer planes 660, 670, and 680.

It should be noted, in one embodiment, that the obtained quarter-resolution images in each color channel after the quarter-resolution demosaicking process have a quarter size of the full-resolution image. In the image-combining process, the quarter-resolution images in the same color channel are combined into a full-resolution image in the same color channel. Specifically, the image-combining process may generate the full-resolution image with the pixels in the quarter-resolution images based on their original positions selected by the image-dividing process. For example, the pixels in the Bayer plane 650 are selected from the upper-left pixel in each quarter in the image-dividing process. Thus, the pixels in the quarter-resolution images 651, 652, and 653 after demosaicking the Bayer plane 650 will be put into the upper-left corner in each 2×2 quarter of the full-resolution image in the blue, green, and red color channel, respectively. Similarly, the pixels in the quarter-resolution images 661, 662, and 663 after demosaicking the Bayer plane 660 will be put into the upper-right corner in each 2×2 quarter of the full-resolution image in the blue, green, and red color channel. The pixels in the quarter-resolution images 671, 672, and 673 after demosaicking the Bayer plane 670 will be put into the bottom-left corner in each 2×2 quarter of the full-resolution image in the blue, green, and red color channel. The pixels in the quarter-resolution images 681, 682, and 683 after demosaicking the Bayer plane 680 will be put into the bottom-right corner in each 2×2 quarter of the full-resolution image in the blue, green, and red color channel. Accordingly, full-resolution images 691, 692, 693 for the blue, green, and red color channels can be obtained after the image-combining process.

FIG. 6B shows a second arrangement of the Bayer planes in accordance with another embodiment of the invention. Since the Bayer pattern includes two green pixels, one blue pixel, and one red pixel, these pixels can be selected from different positions in each 2×2 quarter. As illustrated in FIG. 6B, the upper-left green pixel in the Bayer plane 650 is selected from the bottom-right green pixel 614 in the upper-left quarter 610, and the upper-right blue pixel in the Bayer plane 650 is selected from the upper-left blue pixel 621 in the upper-right quarter 620. The bottom-left red pixel in the Bayer plane 650 is selected from the bottom-left red pixel 633 in the bottom-left quarter 630, and the bottom-right green pixel in the Bayer plane 650 is selected from the upper-left green pixel 641 in the bottom-right quarter 640. Bayer planes 660, 670, and 680 can be obtained using the pixels in the corresponding cells as illustrated in FIG. 6B.

The quarter-resolution demosaicking process in FIG. 6B is similar to that in FIG. 6A. It should be noted that the image-combining process still generates the full-resolution image with the pixels in the quarter-resolution images based on their original positions selected by the image-dividing process. For example, each blue pixel in the quarter-resolution image 650 is assigned to the original position that was previously selected from the input image (i.e. the original positions of the pixels 614, 621, 633, and 641) in the image-dividing process. Similar image combining operations can be performed on the quarter-resolution images 652 and 653 for the green and red color channels.

Specifically, in the embodiment of FIG. 6A, the image-dividing process 411 can be concluded with the following concept: dividing the 4-cell image into 4 Bayer planes, such that G, B, R, G pixels of the k-th Bayer plane are selected from the k-th quadrant of the corresponding G, B, R, G 4-cell arrays, respectively. Additionally, in the embodiment of FIG. 6B, the G, B, R, G pixels of the k-th Bayer plane are respectively selected from the designated quadrants of the corresponding G, B, R, G 4-cell arrays.

With regard to the quarter-resolution demosaicking process 412, the goal of the process is to recover missing red, green, and blue pixels from each Bayer plane. The following illustrates a realization example of the demosaicking process:

Step S4121: For pixel p on a given plane, assume its two missing color channels are r and s, where r and s belong to {R, G, B}. Denote the 3×3 neighborhood centered at p by Uₚ such that there is at least one channel-r pixel and channel-s pixel in the neighborhood Uₚ. Denote the values of missing color channels of p by p(r) and p(s).

Step S4122: Generate mask matrix Vₚ₍ᵣ₎ such that indices of Vₚ₍ᵣ₎ are set ones if the corresponding locations on Uₚ are r-channel pixels, and zeros otherwise. Similarly, generate the mask matrix Vₚ₍ₛ₎ such that indices of Vₚ₍ₛ₎ are set ones if the corresponding locations on Uₚ are s-channel pixels, and zeros otherwise.

Step S4123: Define W by (2). Compute Wₚ₍ᵣ₎, Wₚ₍ₛ₎, and the missing color channels p(r), p(s) as follows, where the operator * is a Hadamard product (i.e. matrix element-wise product). W, Wₚ₍ᵣ₎, and Wₚ₍ₛ₎ are expressed below. Note that in (4-1) and (4-2), (•)_{i,j} denotes index at the i-th row and j-th column of the corresponding matrix (•). The summation in the denominator (and numerator) is done over all (i, j) indices.

$$\begin{matrix}W = [ \begin{matrix}1 & 2 & 1 \\ 2 & 0 & 2 \\ 1 & 2 & 1\end{matrix} ] & ( 2 ) \\ {W}_{p ( r )} = W * {V}_{p ( r )} & ( 3 \text{-} 1 ) \\ {W}_{p ( s )} = W * {V}_{p ( s )} & ( 3 \text{-} 2 ) \\ p ( r ) = \sum {( {U}_{p} * {W}_{p ( r )} )}_{i , j} \text{/} \sum {( {W}_{p ( r )} )}_{i , j} & ( 4 \text{-} 1 ) \\ p ( s ) = \sum {( {U}_{p} * {W}_{p ( s )} )}_{i , j} \text{/} \sum {( {W}_{p ( s )} )}_{i , j} & ( 4 \text{-} 2 )\end{matrix}$$

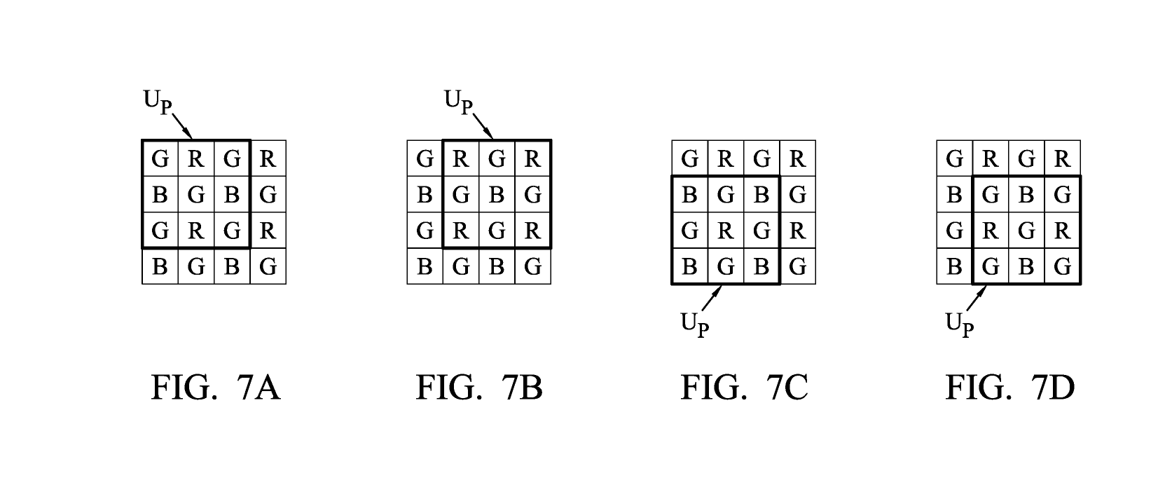

FIGS. 7A-7D are diagrams of different neighborhood areas in the image using the GBRG Bayer pattern in accordance with an embodiment of the invention. For example, if Uₚ is the upper-left 3×3 block in the 4-cell image as shown in FIG. 7A, the missing color channels r=R and s=B, Vₚ₍ᵣ₎ and Vₚ₍ₛ₎ can be expressed as:

$$\begin{matrix}{V}_{p ( r = R )} = [ \begin{matrix}0 & 1 & 0 \\ 0 & 0 & 0 \\ 0 & 1 & 0\end{matrix} ] & ( 5 \text{-} 1 ) \\ {V}_{p ( s = B )} = [ \begin{matrix}0 & 0 & 0 \\ 1 & 0 & 1 \\ 0 & 0 & 0\end{matrix} ] & ( 5 \text{-} 2 )\end{matrix}$$

Similarly, if Uₚ is the upper-right 3×3 block in the 4-cell image as shown in FIG. 7B, the missing color channels r=R and s=G, Vₚ₍ᵣ₎ and Vₚ₍ₛ₎ can be expressed as:

$$\begin{matrix}{V}_{p ( r = R )} = [ \begin{matrix}1 & 0 & 1 \\ 0 & 0 & 0 \\ 1 & 0 & 1\end{matrix} ] & ( 6 \text{-} 1 ) \\ {V}_{p ( s = G )} = [ \begin{matrix}0 & 1 & 0 \\ 1 & 0 & 1 \\ 0 & 1 & 0\end{matrix} ] & ( 6 \text{-} 2 )\end{matrix}$$

If Uₚ is the bottom-left 3×3 block in the 4-cell image as shown in FIG. 7C, the missing color channels r=R and s=B, Vₚ₍ᵣ₎ and Vₚ₍ₛ₎ can be expressed as:

$$\begin{matrix}{V}_{p ( r = G )} = [ \begin{matrix}0 & 1 & 0 \\ 1 & 0 & 1 \\ 0 & 1 & 0\end{matrix} ] & ( 7 \text{-} 1 ) \\ {V}_{p ( s = B )} = [ \begin{matrix}1 & 0 & 1 \\ 0 & 0 & 0 \\ 1 & 0 & 1\end{matrix} ] & ( 7 \text{-} 2 )\end{matrix}$$

If Uₚ is the bottom-right 3×3 block in the 4-cell image as shown in FIG. 7D, the missing color channels r=R and s=B, Vₚ₍ᵣ₎ and Vₚ₍ₛ₎ can be expressed as:

$$\begin{matrix}{V}_{p ( r = R )} = [ \begin{matrix}0 & 0 & 0 \\ 1 & 0 & 1 \\ 0 & 0 & 0\end{matrix} ] & ( 8 \text{-} 1 ) \\ {V}_{p ( s = B )} = [ \begin{matrix}0 & 1 & 0 \\ 0 & 0 & 0 \\ 0 & 1 & 0\end{matrix} ] & ( 8 \text{-} 2 )\end{matrix}$$

Step S4124: Repeat steps S4122 and S4123 for each pixel on the plane.

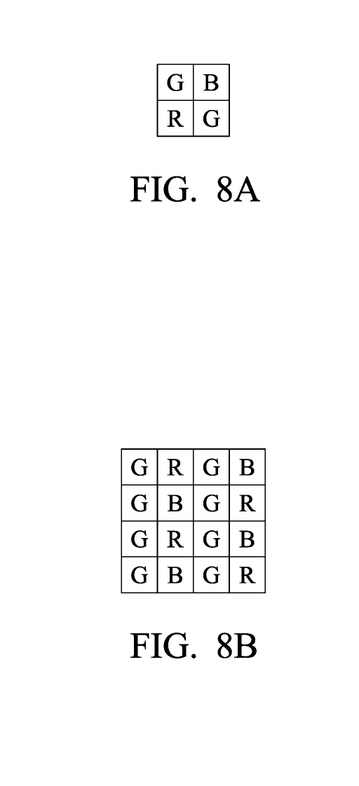

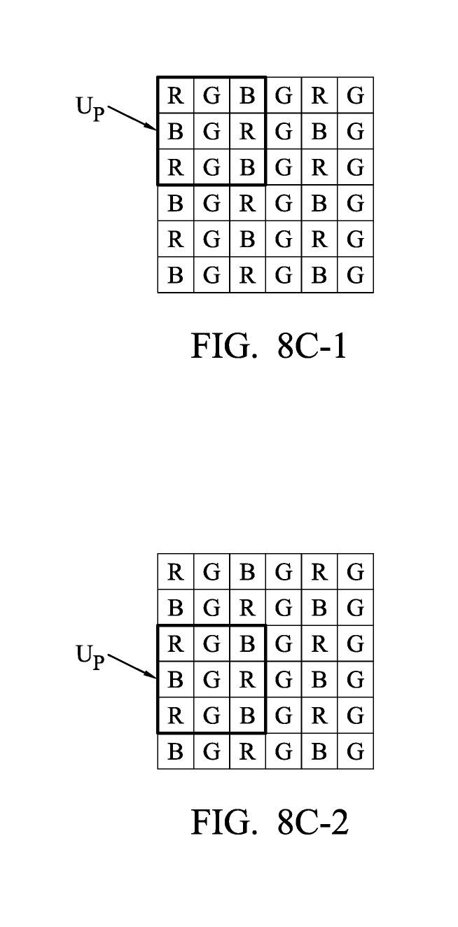

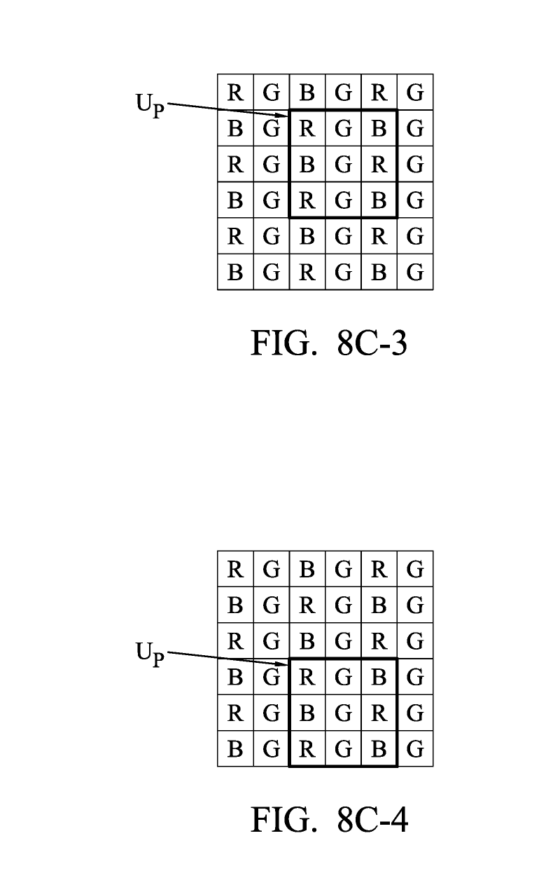

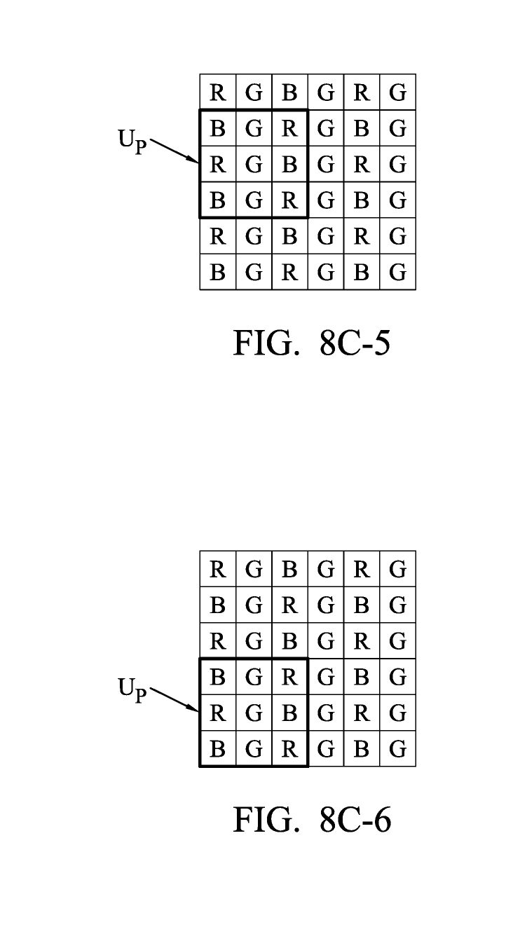

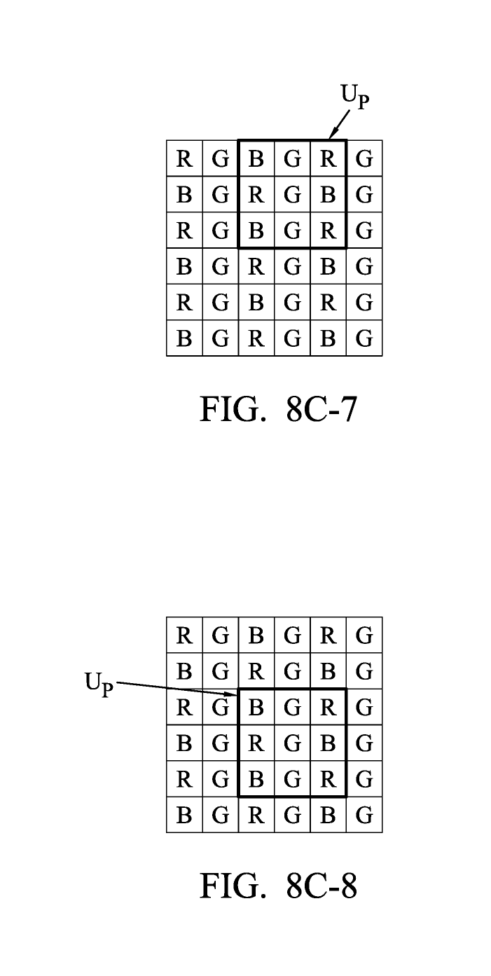

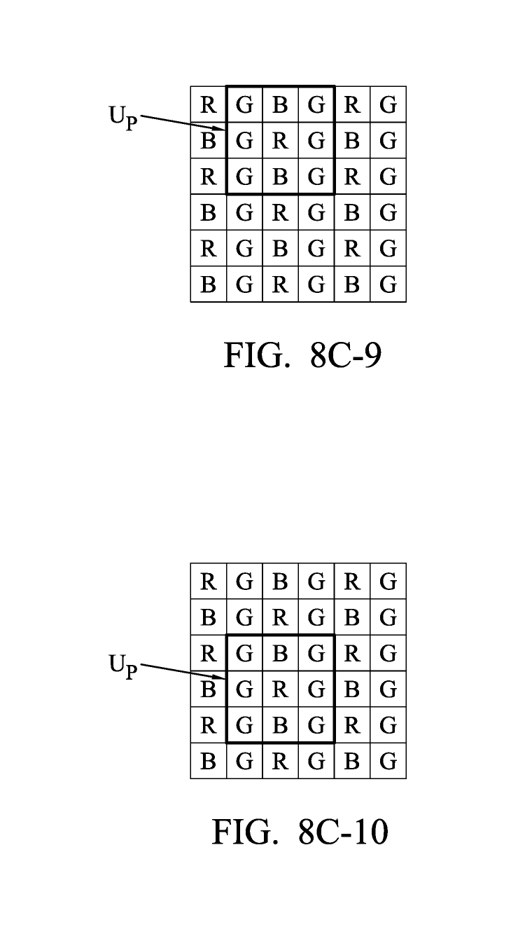

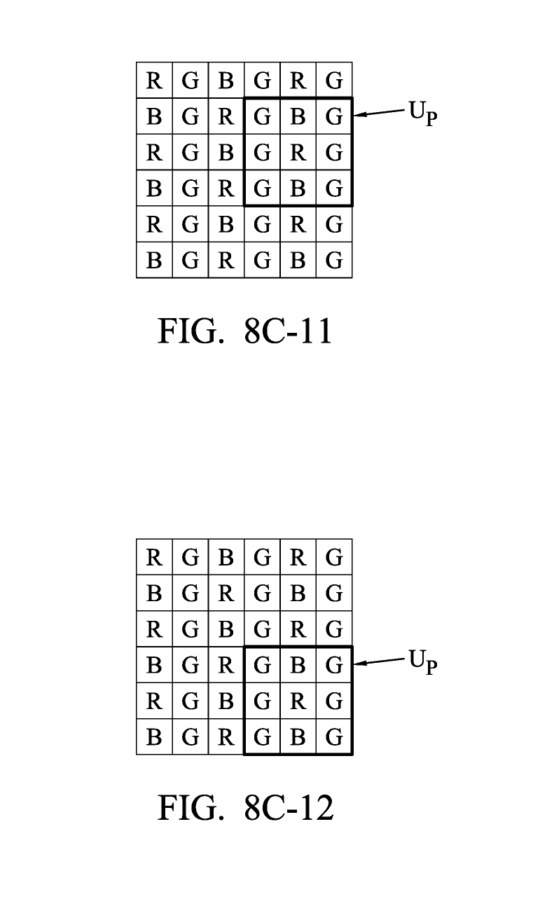

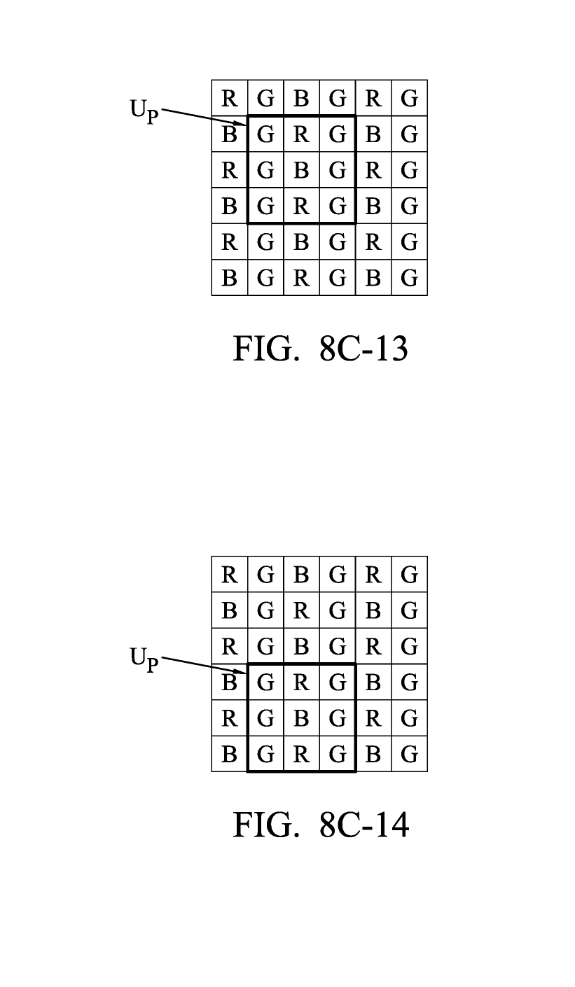

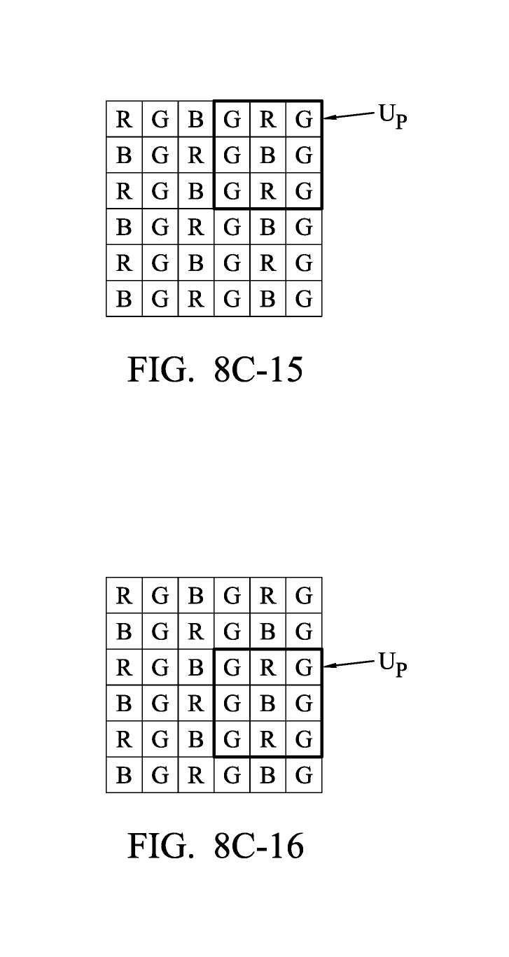

FIG. 8A is an example of the GBRG Bayer pattern. FIG. 8B is an example of the Yamanaka pattern. For purposes of description, the number N is 2 and the number M is 1 in the present embodiment. That is, two different color-resampling methods X₁ and X₂ are used in the color-resampling stage 420, and one color-resampling method Y₁ is used in the image-cascading stage 450.

Let X₁ denote the first color-resampling method using the GBRG Bayer pattern and X₂ denote the second color-resampling method using the Yamanaka pattern in the color-resampling stage 420. The demosaicking process in the color-reconstruction stage 430 for the first color-resampling method X₁ can be referred to in the embodiments of FIGS. 7A-7D.

FIGS. 8C-1˜8C-16 are diagrams of different 3×3 neighborhood areas in different types in the image using the Yamanaka pattern in accordance with an embodiment of the invention. The equations for demosaicking the color-resampled image using the Yamanaka pattern is similar to those using the GBRG Bayer pattern, such as equations 2˜4. In the type 1 patterns shown in FIGS. 8C-1˜8C-4, the center of the 3×3 neighborhood area Uₚ is located on one of the green pixels of the color-resampled image 800 using the X₂ color-resampling method. The mask matrices Vₚ₍ᵣ₎ for the missing colors R and B in the type 1 patterns can be expressed by the following equations:

$$\begin{matrix}{V}_{p ( r = R )} = [ \begin{matrix}1 & 0 & 0 \\ 0 & 0 & 1 \\ 1 & 0 & 0\end{matrix} ] & ( 9 \text{-} 1 ) \\ {V}_{p ( s = B )} = [ \begin{matrix}0 & 0 & 1 \\ 1 & 0 & 0 \\ 0 & 0 & 1\end{matrix} ] & ( 9 \text{-} 2 )\end{matrix}$$

In the type 2 patterns shown in FIGS. 8C-5˜8C-8, the center of the 3×3 neighborhood area Uₚ is also located on one of the green pixels of the color-resampled image 800 using the X₂ color-resampling method. However, the arrangement of blue and red pixels in the 3×3 neighborhood area Uₚ in the type 2 patterns is different from that in type 1 patterns. The mask matrices Vₚ₍ᵣ₎ for the missing colors R and B in the type 2 patterns can be expressed by the following equations:

$$\begin{matrix}{V}_{p ( r = R )} = [ \begin{matrix}0 & 0 & 1 \\ 1 & 0 & 0 \\ 0 & 0 & 1\end{matrix} ] & ( 10 \text{-} 1 ) \\ {V}_{p ( s = B )} = [ \begin{matrix}1 & 0 & 0 \\ 0 & 0 & 1 \\ 1 & 0 & 0\end{matrix} ] & ( 10 \text{-} 2 )\end{matrix}$$

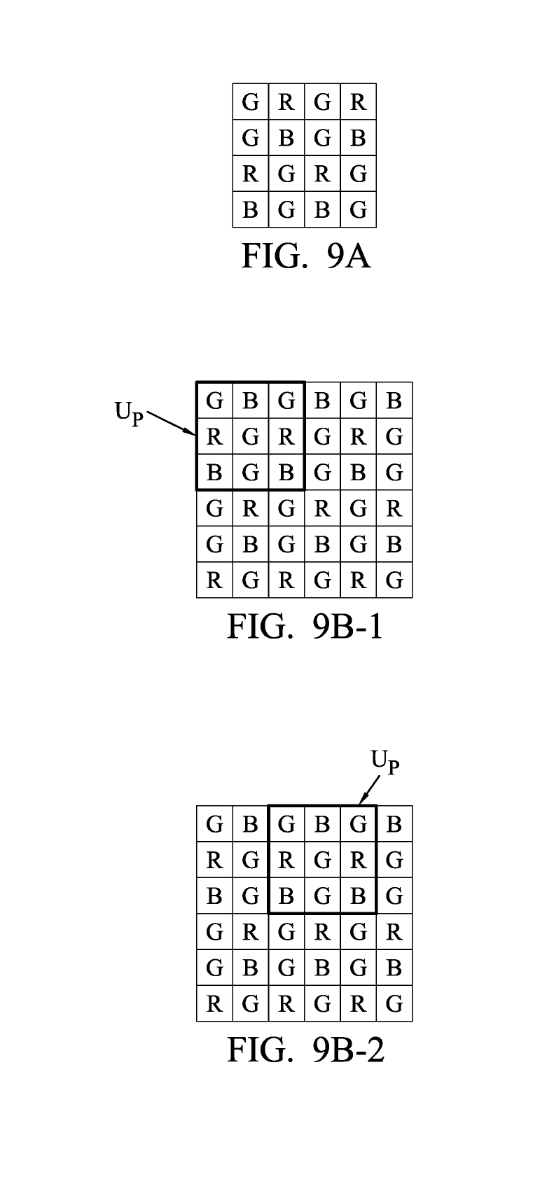

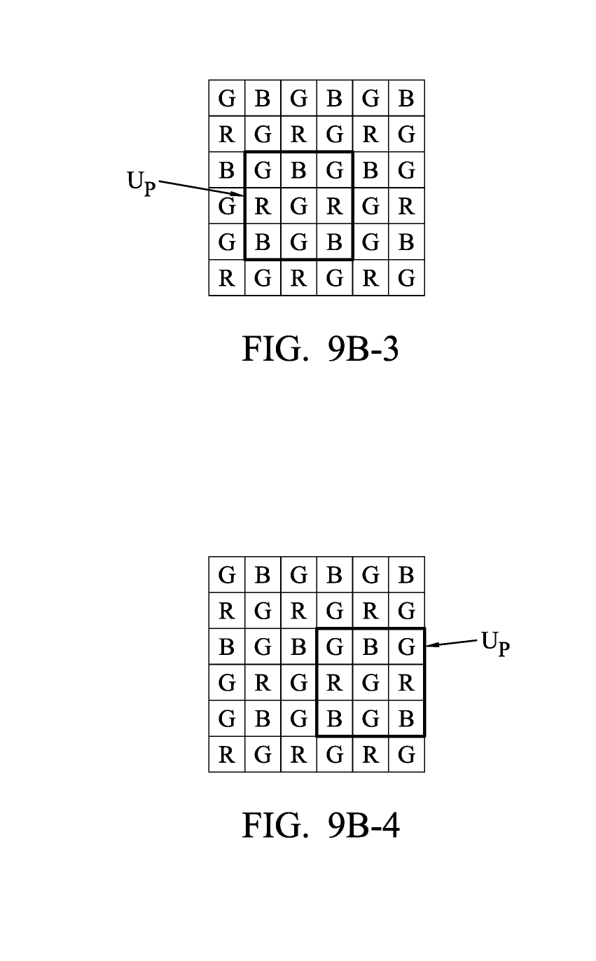

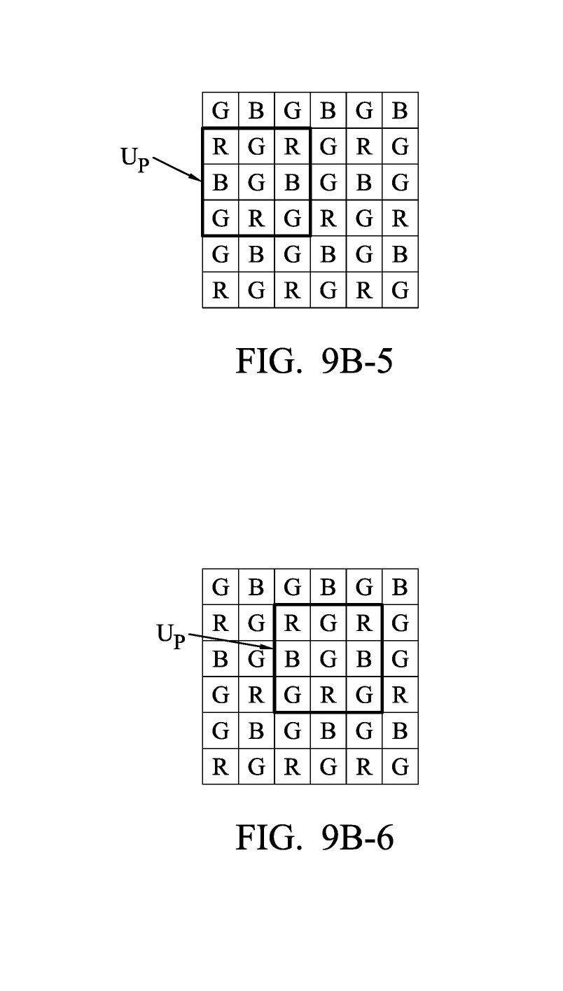

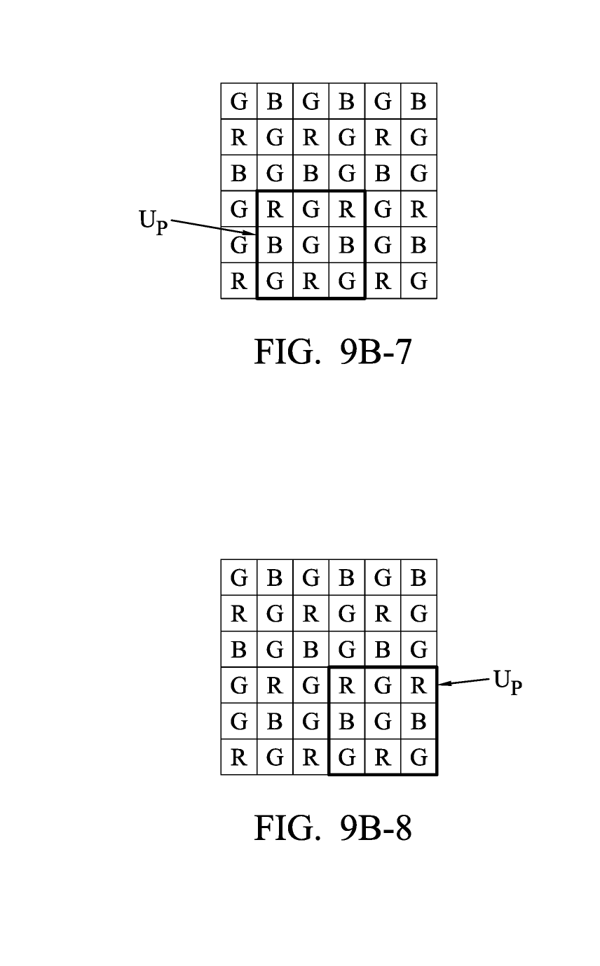

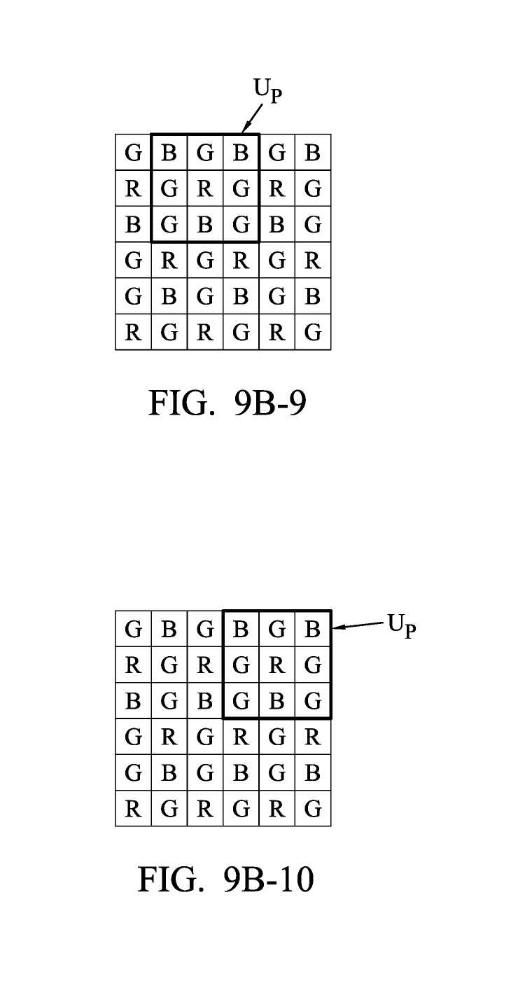

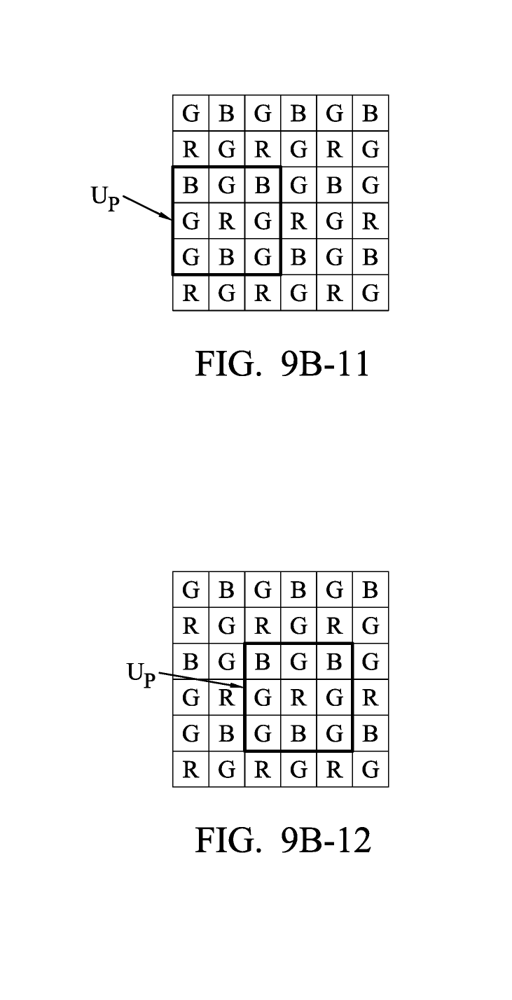

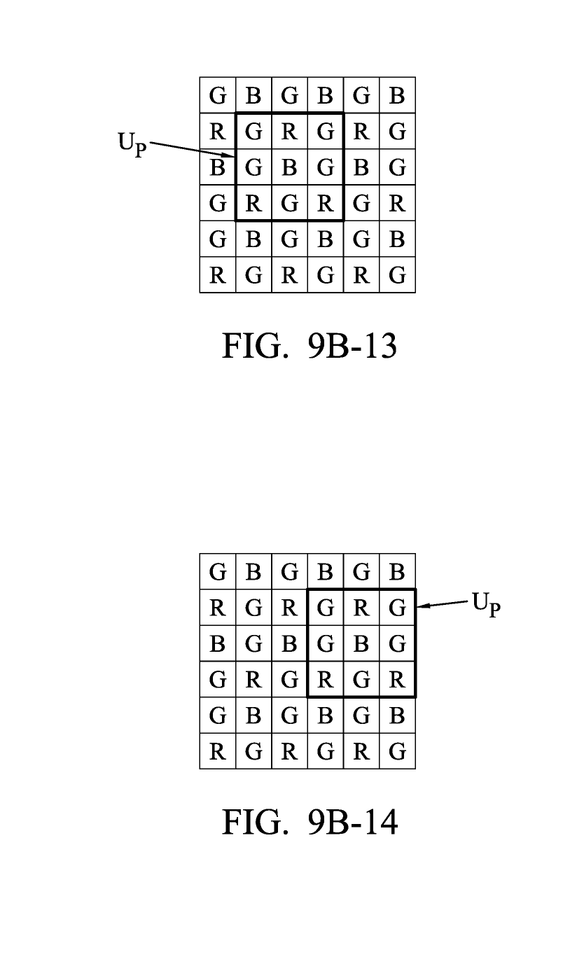

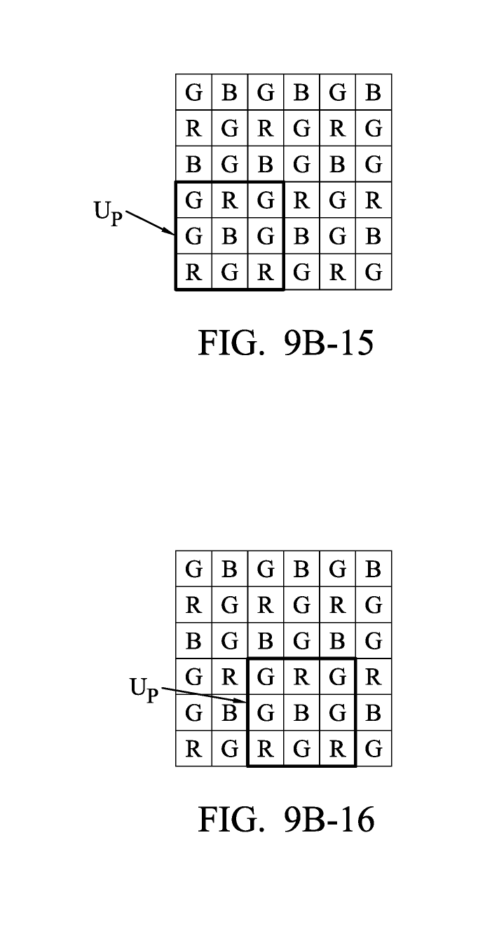

In the type 3 patterns shown in FIGS. 8C-9˜8C-12, the center of the 3×3 neighborhood area Uₚ is located on one of the red pixels of the color-resampled image 800 using the X₂ color-resampling method. The mask matrices Vₚ₍ᵣ₎ for the missing colors G and B in the type 3 patterns can be expressed by the following equations:

$$\begin{matrix}{V}_{p ( r = G )} = [ \begin{matrix}1 & 0 & 1 \\ 1 & 0 & 1 \\ 1 & 0 & 1\end{matrix} ] & ( 11 \text{-} 1 ) \\ {V}_{p ( s = B )} = [ \begin{matrix}0 & 1 & 0 \\ 0 & 0 & 0 \\ 0 & 1 & 0\end{matrix} ] & ( 11 \text{-} 2 )\end{matrix}$$

In the type 4 patterns shown in FIGS. 8C-13˜8C-16, the center of the 3×3 neighborhood area Uₚ is located on one of the blue pixels of the color-resampled image 800 using the X₂ color-resampling method. The mask matrices Vₚ₍ᵣ₎ for the missing colors R and G in the type 4 patterns can be expressed by the following equations:

$$\begin{matrix}{V}_{p ( r = R )} = [ \begin{matrix}0 & 1 & 0 \\ 0 & 0 & 0 \\ 0 & 1 & 0\end{matrix} ] & ( 12 \text{-} 1 ) \\ {V}_{p ( s = G )} = [ \begin{matrix}1 & 0 & 1 \\ 1 & 0 & 1 \\ 1 & 0 & 1\end{matrix} ] & ( 12 \text{-} 2 )\end{matrix}$$

FIG. 9A is an example of the Lukac pattern. Let Y₁ denotes the first color-resampling method in the image-cascading stage 450. In the present embodiment, the Lukac is used in method Y₁, as illustrated in FIG. 9A.

FIGS. 9B-1˜9B-16 are diagrams of different 3×3 neighborhood areas in different types in the image using the Lukac pattern in accordance with an embodiment of the invention. The equations for demosaicking the color-resampled image using the Lukac pattern is similar to those using the GBRG Bayer pattern, such as equations 2˜4. In the type 1 patterns shown in FIGS. 9B-1˜9B-4, the center of the 3×3 neighborhood area Uₚ is located on one of the green pixels of the color-resampled image 800 using the X₂ color-resampling method. The mask matrices Vₚ₍ᵣ₎ for the missing colors R and B in the type 1 patterns can be expressed by the following equations:

$$\begin{matrix}{V}_{p ( r = R )} = [ \begin{matrix}0 & 0 & 0 \\ 1 & 0 & 1 \\ 0 & 0 & 0\end{matrix} ] & ( 13 \text{-} 1 ) \\ {V}_{p ( s = B )} = [ \begin{matrix}0 & 1 & 0 \\ 0 & 0 & 0 \\ 1 & 0 & 1\end{matrix} ] & ( 13 \text{-} 2 )\end{matrix}$$

In the type 2 patterns shown in FIGS. 9B-5˜9B-8, the center of the 3×3 neighborhood area Uₚ is also located on one of the green pixels of the color-resampled image 800 using the X₂ color-resampling method. However, the arrangement of blue and red pixels in the 3×3 neighborhood area Uₚ in the type 2 patterns is different from that in type 1 patterns. The mask matrices Vₚ₍ᵣ₎ for the missing colors R and B in the type 2 patterns can be expressed by the following equations:

$$\begin{matrix}{V}_{p ( r = R )} = [ \begin{matrix}1 & 0 & 1 \\ 0 & 0 & 0 \\ 0 & 1 & 0\end{matrix} ] & ( 14 \text{-} 1 ) \\ {V}_{p ( s = B )} = [ \begin{matrix}0 & 0 & 0 \\ 1 & 0 & 1 \\ 0 & 0 & 0\end{matrix} ] & ( 14 \text{-} 2 )\end{matrix}$$

In the type 3 patterns shown in FIGS. 9B-9˜9B-12, the center of the 3×3 neighborhood area Uₚ is located on one of the red pixels of the color-resampled image 800 using the X₂ color-resampling method. The mask matrices Vₚ₍ₜ₎ for the missing colors G and B in the type 3 patterns can be expressed by the following equations:

$$\begin{matrix}{V}_{p ( r = G )} = [ \begin{matrix}0 & 1 & 0 \\ 1 & 0 & 1 \\ 1 & 0 & 1\end{matrix} ] & ( 15 \text{-} 1 ) \\ {V}_{p ( s = B )} = [ \begin{matrix}1 & 0 & 1 \\ 0 & 0 & 0 \\ 0 & 1 & 0\end{matrix} ] & ( 15 \text{-} 2 )\end{matrix}$$

In the type 4 patterns shown in FIGS. 9B-13˜9B-16, the center of the 3×3 neighborhood area Uₚ is located on one of the blue pixels of the color-resampled image 800 using the X₂ color-resampling method. The mask matrices Vₚ₍ᵣ₎ for the missing colors R and G in the type 4 patterns can be expressed by the following equations:

$$\begin{matrix}{V}_{p ( r = R )} = [ \begin{matrix}0 & 1 & 0 \\ 0 & 0 & 0 \\ 1 & 0 & 1\end{matrix} ] & ( 16 \text{-} 1 ) \\ {V}_{p ( s = G )} = [ \begin{matrix}1 & 0 & 1 \\ 1 & 0 & 1 \\ 0 & 1 & 0\end{matrix} ] & ( 16 \text{-} 2 )\end{matrix}$$

It should be noted that the color-resampling methods X₁, X₂, and Y₁ and the mask matrices in the aforementioned embodiments are examples showing how to implement the stages 420, 430, and 450, and the invention is not limited to the aforementioned color-resampling and demosaicking methods.

In view of the above, a demosaicking method and circuit for a multi-cell image sensor is provided. The demosaicking method and circuit may adapt existing or newly developed color-resampling and demosaicking algorithms to recover the original image from the mosaicked image captured by the multi-cell image sensor with better image quality.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A demosaicking method for an image having a multi-cell mosaic pattern, wherein the multi-cell mosaic pattern comprises a first quarter, a second quarter, a third quarter, and a fourth quarter, each quarter comprises multiple cells, and each cell includes a pixel value, the method comprising:
obtaining the image;
performing an image-dividing process on the image to obtain four Bayer plane images;
performing a quarter-resolution demosaicking process on each of the four Bayer plane images to obtain a quarter-resolution image in each color channel; and
performing an image-combining process on the quarter-resolution images of the four Bayer plane images in each color channel to generate a first full-resolution image in each color channel.

2. The demosaicking method as claimed in claim 1, wherein the pixel value of the cells in the first quarter is in a first-color channel, the pixel value of the cells in the second quarter is in a second-color channel, the pixel value of the cells in the third quarter is in a third-color channel, and the pixel value of the cells in the fourth quarter is in a fourth-color channel, in the image-dividing process:
a first-color pixel, a second-color pixel, a third-color pixel, and a fourth-color pixel of the k-th Bayer plane image are respectively selected from the k-th quadrant of the corresponding k-th quarter in the image, where k is an integer from 1 to 4.

3. The demosaicking method as claimed in claim 1, wherein the pixel value of the cells in the first quarter is in a first-color channel, the pixel value of the cells in the second quarter is in a second-color channel, the pixel value of the cells in the third quarter is in a third-color channel, and the pixel value of the cells in the fourth quarter is in a fourth-color channel, in the image-dividing process:
a first-color pixel, a second-color pixel, a third-color pixel, and a fourth-color pixel of the k-th Bayer plane image are respectively selected from a designated quadrant of a corresponding quarter in the image, where k is an integer from 1 to 4.

4. The demosaicking method as claimed in claim 1, wherein a first 3×3 mask and a second 3×3 mask are used in the quarter-resolution demosaicking process to interpolate a first missing color component and a second missing color component relative to a center of the first 3×3 mask and the second 3×3 mask in the Bayer plane images.

5. The demosaicking method as claimed in claim 1, wherein the image-combining process comprises:
generating the first full-resolution image in each color channel by filling pixels in the quarter-resolution image in the same color channel based on their original positions in the image selected by the image-dividing process.

6. The demosaicking method as claimed in claim 1, further comprising:
performing a color-resampling process on the first full-resolution image in each color channel to obtain one or more color-resampled images; and
performing a color-reconstruction process on the one or more color-resample images to obtain one or more second full-resolution images in each color channel.

7. The demosaicking method as claimed in claim 6, wherein the color-resampling process comprises one or more first color-resampling methods that are performed in parallel, and the color-reconstruction process comprises one or more first demosaicking methods, where each first demosaicking method corresponds to one of the first color-resampling methods.

8. The demosaicking method as claimed in claim 6, further comprising:
performing an image-blending process on the one or more second full-resolution images in each color channel to generate a fused full-resolution image in each color channel,
wherein a weighted average method is used on the one or more second full-resolution images in each color channel to generate the fused full-resolution image in each color channel.

9. The demosaicking method as claimed in claim 8, further comprising:
performing an image-cascading process on the fused full-resolution image in each color channel to obtain third full-resolution image in each color channel,
wherein the image-cascading process comprises one or more second color-resampling methods and second demosaicking methods, and each second color-resampling method corresponds to one of the second demosaicking methods,
wherein one or more iterations are performed in the image-cascading process, and each iteration comprises one of the second color-resampling methods and a corresponding second demosaicking method.

10. A demosaicking circuit for processing an image having a multi-cell mosaic pattern, wherein the multi-cell mosaic pattern comprises a first quarter, a second quarter, a third quarter, and a fourth quarter, each quarter comprises multiple cells, and each cell includes a pixel value, the demosaicking circuit comprising:
an initial demosaicking circuit, configured to:
obtain the image;
perform an image-dividing process on the image to obtain four Bayer plane images;
perform a quarter-resolution demosaicking process on each of the four Bayer plane images to obtain a quarter-resolution image in each color channel; and
perform an image-combining process on the quarter-resolution image in each color channel to generate a first full-resolution image in each color channel.

11. The demosaicking circuit as claimed in claim 10, wherein the pixel value of the cells in the first quarter is in a green color channel, the pixel value of the cells in the second quarter is in a blue color channel, the pixel value of the cells in the third quarter is in a red color channel, and the pixel value of the cells in the fourth quarter is in the green color channel, in the image-dividing process:
a first green pixel, a blue pixel, a red pixel, and a second green pixel of the k-th Bayer plane image are respectively selected from the k-th quadrant of the corresponding k-th quarter in the image, where k is an integer from 1 to 4.

12. The demosaicking circuit as claimed in claim 10, wherein the pixel value of the cells in the first quarter is in a green color channel, the pixel value of the cells in the second quarter is in a blue color channel, the pixel value of the cells in the third quarter is in a red color channel, and the pixel value of the cells in the fourth quarter is in the green color channel, in the image-dividing process:
a first green pixel, a blue pixel, a red pixel, and a second green pixel of the k-th Bayer plane image are respectively selected from a designated quadrant of a corresponding quarter in the image, where k is an integer from 1 to 4.

13. The demosaicking circuit as claimed in claim 10, wherein a first 3×3 mask and a second 3×3 mask are used in the quarter-resolution demosaikcing process to interpolate a first missing color component and a second missing color component relative to a center of the first 3×3 mask and the second 3×3 mask in the Bayer plane images.

14. The demosaicking circuit as claimed in claim 12, wherein the initial demosaicking circuit is further configured to generate the first full-resolution image in each color channel by filling pixels in the quarter-resolution image in the same color channel based on their original positions selected by the image-dividing process.

15. The demosaicking circuit as claimed in claim 10, further comprising:
a color-resampling circuit, configured to perform a color-resampling process on the first full-resolution image in each color channel to obtain one or more color-resampled images; and
a color-reconstruction circuit, configured to perform a color-reconstruction process on the one or more color-resample images to obtain one or more second full-resolution images in each color channel.

16. The demosaicking circuit as claimed in claim 15, wherein the color-resampling process comprises one or more first color-resampling methods that are performed in parallel, and the color-reconstruction process comprises one or more first demosaicking methods, where each first demosaicking method corresponds to one of the first color-resampling methods.

17. The demosaicking circuit as claimed in claim 15, further comprising:
an image-blending circuit, configured to perform an image-blending process on the one or more second full-resolution images in each color channel to generate a fused full-resolution image in each color channel,
wherein a weighted average method is used on the one or more second full-resolution images in each color channel to generate the fused full-resolution image in each color channel.

18. The demosaicking circuit as claimed in claim 17, further comprising:
an image-cascading circuit, configured to perform an image-cascading process on the fused full-resolution image in each color channel to obtain third full-resolution image in each color channel,
wherein the image-cascading process comprises one or more second color-resampling methods and second demosaicking methods, and each second color-resampling method corresponds to one of the second demosaicking methods,
wherein one or more iterations are performed in the image-cascading process, and each iteration comprises one of the second color-resampling methods and a corresponding second demosaicking method.

19. A demosaicking circuit for processing an image having a multi-cell mosaic pattern, wherein the multi-cell mosaic pattern comprises a first quarter, a second quarter, a third quarter, and a fourth quarter, each quarter comprises multiple cells, and each cell includes a pixel value, the demosaicking circuit comprising:
an initial demosaicking circuit, configured to:
obtain the image;
perform an image-dividing process on the image to obtain four Bayer plane images;
perform a quarter-resolution demosaicking process on each of the four Bayer plane images to obtain a quarter-resolution image in each color channel; and
perform an image-combining process on the quarter-resolution image in each color channel to generate a first full-resolution image in each color channel; and
an image-cascading circuit, configured to perform an image-cascading process on the first full-resolution image in each color channel to obtain a second full-resolution image in each color channel,
wherein the image-cascading process comprises one or more second color-resampling methods and second demosaicking methods, and each second color-resampling method corresponds to one of the second demosaicking methods,
wherein one or more iterations are performed in the image-cascading process, and each iteration comprises one of the second color-resampling methods and a corresponding second demosaicking method.

20. The demosaicking circuit as claimed in claim 19, further comprising:
a color-resampling circuit, configured to perform a color-resampling process on the second full-resolution image in each color channel to obtain one or more color-resampled images;
a color-reconstruction circuit, configured to perform a color-reconstruction process on the one or more color-resample images to obtain one or more third full-resolution images in each color channel; and
an image-blending circuit, configured to perform an image-blending process on the one or more third full-resolution images in each color channel to generate a fused full-resolution image in each color channel.
